(19) United States
(12) Patent Application Publication
(10) Pub. No.: US 2024/0231577 A1
(43) Pub. Date: Jul. 11, 2024

(54) CONTENT EDITING CONTROL METHOD, DEVICE, AND COMPUTER PROGRAM FOR FINE ADJUSTMENT CONTROL

(71) Applicant: KINEMASTER CORPORATION, Seoul (KR)

(72) Inventor: Jong Deuk KIM, Seongnam-si, Gyeonggi-do (KR)

(21) Appl. No.: 18/557,000

(22) PCT Filed: Apr. 29, 2022
(86) PCT No.: PCT/KR2022/006189

§ 371 Date: Oct. 24, 2023

(30) Foreign Application Priority Data
Apr. 29, 2021 (KR) 10-2021-0055860
Apr. 29, 2022 (KR) 10-2022-0053278

(51) Int. Cl. G06F 3/0484; G06F 3/0482; G06F 3/0488

(52) U.S. Cl. CPC G06F 3/0484; G06F 3/0482; G06F 3/0488

(57) ABSTRACT

Disclosed herein a content editing control method, device and computer program for fine adjustment control. The method includes: detecting initiation of a change of an object; presenting an adjustment menu related to the change of the object; receiving an adjustment item selected by input of a user in the adjustment menu; and controlling the change of the object according to an instruction of the user based on settings of the adjustment item specified by the user.

### TECHNICAL FIELD

The present disclosure relates to a content editing control method, device and computer program for fine adjustment control, and to a content editing control method, device and computer program that provide a fine adjustment interface for various types of object changes.

### BACKGROUND ART

Recently, as portable terminals such as smartphones and tablets have been widely spread, performance of these portable terminals has been improved and wireless communication technology has been developed, users can shoot, edit, and share videos using their portable terminals.

However, in portable terminals, due to limitations in the size of a display screen and performance of hardware, users cannot smoothly edit videos as in a general PC environment. In order to improve this inconvenience, user demand for a video editing method that can be used in a portable terminal is increasing.

Furthermore, as the needs of users of portable terminals increase, the performances of camera devices, display devices, and hardware of portable terminals are being upgraded, and many functions or services used in PC environments are being performed by portable terminals. In particular, since portable terminals are basically provided with a camera device, user needs for editing still images or videos captured through the camera device are increasing.

Meanwhile, due to the nature of the resources of portable terminals, video editing methods have been spread to use only limited functions, but there is a demand for video editing to a level equivalent to that of a PC environment.

Mobile terminals are generally equipped with a display device that supports touch input. When processing user input for editing through a small-area display device that supports touch input, it is not easy to adjust the position and size of media layers on an editing screen or to perform detailed settings for media clips on the timeline. Taking this into consideration, there is a need to provide a user interface capable of simple and intuitive fine adjustment.

### DISCLOSURE

### Technical Problem

An object of the present disclosure is to provide a content editing control method, device, and computer program that provide a fine adjustment interface for various types of object changes.

Another object of the present disclosure is to provide a content editing control method, device, and computer program that can intuitively process various functions for video editing.

Another object of the present disclosure is to provide a content editing control method, device, and computer program that present a fine adjustment user interface configured in a simplified structure and design.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### Technical Solution

According to present disclosure, there is provided a content editing control method for fine adjustment control, the method including: detecting initiation of a change of an object;
presenting an adjustment menu related to the change of the object;
receiving an adjustment item selected by input of a user in the adjustment menu; and controlling the change of the object according to an instruction of the user based on settings of the adjustment item specified by the user.

According to the embodiment of the present disclosure in the method, the object may be a media object or an editing tool for editing the media object.

According to the embodiment of the present disclosure in the method, the object may be provided to a display of an electronic device, and the change of the object may be performed by an editing interface provided on the display to receive touch input of the user.

According to the embodiment of the present disclosure in the method, the touch input may be input by a drag gesture of the user, and the change of the object includes control of the change of the object based on the drag gesture.

According to the embodiment of the present disclosure in the method, the presenting the adjustment menu may include providing the adjustment menu to the display in a state of maintaining the touch input related to the drag gesture.

According to the embodiment of the present disclosure in the method, the controlling the change of the object according to the instruction of the user may be performed in a state of maintaining touch input for the specified adjustment item. The method may further include interrupting provision of the adjustment item and presenting an adjustment menu having an adjustment control type according to a type of the change of the object, in response to release of the touch input for the adjustment item; and interrupting presentation of the adjustment menu in response to release of the touch input related to the drag gesture.

According to the embodiment of the present disclosure in the method, the presenting the adjustment menu may include: providing the user with at least one adjustment control type according to the type of the change of the object; and providing the adjustment item based on the adjustment control type selected by the user.

According to the embodiment of the present disclosure in the method, the change of the object may be performed by an editing interface for receiving touch input related to the drag gesture of the user, and the adjustment control type may include at least one of a snap function or a speed adjustment function according to the drag gesture, and the snap function controls the change of the object to be automatically aligned to a predetermined alignment reference object.

According to the embodiment of the present disclosure in the method, the speed adjustment function may provide an adjustment item including a range from a value smaller than a default value to a larger value based on the default value according to the drag gesture.

According to the embodiment of the present disclosure in the method, the adjustment item according to the snap function and the predetermined alignment reference object may be determined based on the type of the change of the object.

According to another present disclosure, there is provided a content editing device for fine adjustment control, the device including: a memory configured to store at least one instruction; a display configured to display media; and a processor configured to execute the at least one instruction stored in the memory. The processor is configured to: detect initiation of a change of an object; present an adjustment menu related to the change of the object; receive an adjustment item selected by input of a user in the adjustment menu; and control the change of the object according to an instruction of the user based on settings of the adjustment item specified by the user.

According to another present disclosure, there is provided a computer program stored in a recording medium readable by a computing electronic device to perform a content editing control method for fine adjustment control in the computing electronic device, the method including: detecting initiation of a change of an object; presenting an adjustment menu related to the change of the object; receiving an adjustment item selected by input of a user in the adjustment menu; and controlling the change of the object according to an instruction of the user based on settings of the adjustment item specified by the user.

The features briefly summarized above for this disclosure are only exemplary aspects of the detailed description of the disclosure which follow, and are not intended to limit the scope of the disclosure.

### Effects of Invention

According to the present disclosure, it is possible to provide a content editing control method, device, and computer program that provide a fine adjustment interface for various types of object changes.

Specifically, the fine adjustment user interface that is adaptively configured for various adjustment targets can be generated simply and intuitively, without the need to configure a fine adjustment UI having a complicated structure or various fine adjustment UI designed for each adjustment target.

According to the present disclosure, it is possible to provide an environment capable of performing smooth editing while efficiently using resources of a portable electronic device, by realizing a fine adjustment interface with a simplified structure and low capacity.

According to the present disclosure, it is possible to significantly improve user convenience by easily inputting and processing fine adjustment in a portable electronic device equipped with a display device (display) with a limited size.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a diagram illustrating an electronic device to which various embodiments of the present disclosure are applied.

FIG. 2 is a diagram illustrating a system hierarchy structure of an electronic device to which various embodiments of the present disclosure are applied.

FIG. 3 is a flowchart illustrating a video editing method to which various embodiments of the present disclosure are applied.

FIG. 4 is a diagram illustrating an editing UI provided by a video editing UI control apparatus according to various embodiments of the present disclosure.

FIGS. 5A to 5E are diagrams illustrating a clip editing UI provided by a video editing UI according to various embodiments of the present disclosure.

FIG. 6 is a flowchart of a content editing control method for fine adjustment control according to an embodiment of the present disclosure.

FIGS. 7A to 7E are diagrams illustrating a process of implementing a content editing method according to an embodiment of the present disclosure.

FIG. 8 is a flowchart of a content editing control method for fine adjustment control according to another embodiment of the present disclosure.

FIGS. 9A to 9D are diagrams illustrating as an example a process of implementing a content editing method according to another embodiment of the present disclosure.

FIGS. 10A to 10D are diagrams illustrating as another example a process of implementing a content editing method according to another embodiment of the present disclosure.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

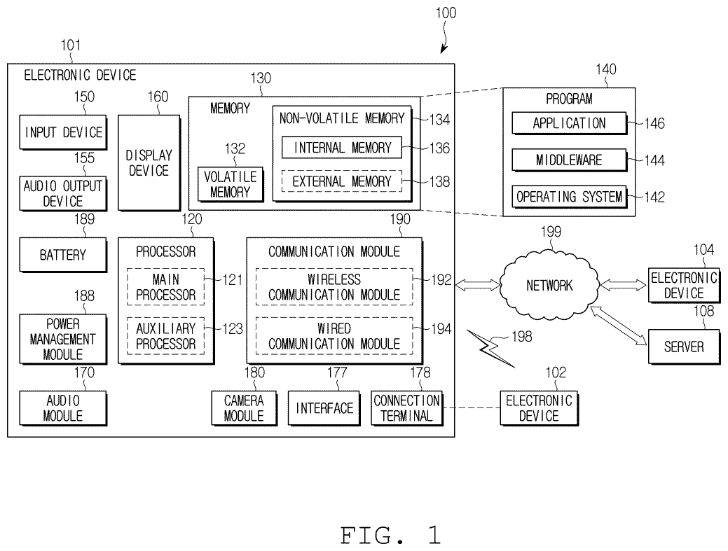

Various embodiments of the present disclosure may be implemented in an electronic device including a communication module, a memory, a display device (or display), and a processor, and a content editing device according to an embodiment of the present disclosure may be implemented by an electronic device (e.g., 101, 102, and 104 in FIG. 1) having an editing application embedded therein. According to the present disclosure, the electronic device may be a type of computing device according to the present disclosure. For convenience of description, in the present disclosure, an editing application is described as an example of a content editing application or a video (or image) editing application. Content may include not only videos and images, but also various types of media objects, such as audio, voice, music, text, and graphics. Also, the content editing device may be implemented by an electronic device having an image processing unit and a controller capable of processing videos (or images) and subtitle data.

Preferably, an electronic device to which various embodiments of the present disclosure are applied means a portable electronic device. The electronic device may be a user device, and the user device may be various types of devices such as, for example, a smartphone, a tablet PC, a laptop, and a desktop.

FIG. 1 is a block diagram illustrating an electronic device 101 in a network environment 100, as a diagram illustrating an electronic device to which various embodiments of the present disclosure are applied. Here, the electronic device 101 may be referred to as a computing device, and the electronic device 101 may have a built-in content editing application or an application downloaded from the outside and installed therein.

Referring to FIG. 1, in the network environment 100, the electronic device 101 communicates with an electronic device 102 through a first network 198 (e.g., short-range wireless communication), or communicate with an electronic device 104 or a server 108 through a second network 199 (e.g., a long-distance wireless communication). According to an embodiment, the electronic device 101 may communicate with the electronic device 104 through the server 108. According to an embodiment, the electronic device 101 may include a processor 120, a memory 130, an input device 150, an audio output device 155, a display device 160, an audio module 170, and an interface 177, a camera module 180, a power management module 188, a battery 189, a communication module 190 for transmitting and receiving data through networks 198 and 199, and the like. In another embodiment, in the electronic device 101, at least one of these components (e.g., the display device 160 or the camera module 180) may be omitted or another component may be added.

The processor 120 may for example, drive software (e.g., program 140) to control at least one other component (e.g., hardware or software component) of the electronic device 101 connected to the processor 120 and perform various data processing and calculations. The processor 120 may load and process commands or data received from another component (e.g., the communication module 190) into a volatile memory 132, and store resultant data in a non-volatile memory 134. According to an embodiment, the processor 120 may include a main processor 121 (e.g., a central processing unit or an application processor) and an auxiliary processor 123 that operates independently of the main processor 121. For example, the auxiliary processor 123 may be additionally or alternatively mounted on the main processor 121 to use less power than the main processor 121. As another example, the auxiliary processor 123 may include an auxiliary processor 123 (e.g., a graphic processing unit, an image signal processor, a sensor hub processor, or a communication processor) specialized for a designated function. Here, the auxiliary processor 123 may be operated separately from or embedded in the main processor 121.

In this case, the auxiliary processor 123 may for example, control at least some of functions or states related to at least one (e.g., the display device 160 or the communication module 190) of the components of the electronic device 101 in place of the main processor 121, while the main processor 121 is in an inactive (e.g., sleep) state. As another example, while the main processor 121 is in an active (e.g., application execution) state, the auxiliary processor 123, along with the main processor 121, may control at least some of functions or states related to at least components of the electronic device 101.

According to an embodiment, the auxiliary processor 123 (e.g., an image signal processor or a communication processor) may be implemented as a part of another functionally related component (e.g., the camera module 180 or the communication module 190). The memory 130 may store various data, for example, software (e.g., program 140), used by at least one component of the electronic device 101 (e.g., the processor 120) and input data or output data for commands related thereto. The memory 130 may include a volatile memory 132 or a non-volatile memory 134. The non-volatile memory 134 may be, for example, an internal memory 136 mounted in the electronic device 101 or an external memory 138 connected through an interface 177 of the electronic device 101. Original media, such as images captured by the camera module 180 and images obtained from the outside, video projects created through editing applications, and related data are allocated to and stored in at least one some areas of the internal and/or external memories 136 and 138 by settings of the electronic device 101 or according to user requests.

The program 140 is software stored in the memory 130, and may include, for example, an operating system 142, middleware 144, or an application 146. The application 146 may include a plurality of software for various functions, and may have a content editing application according to the present disclosure. The editing application is executed by the processor 140 and may be software that creates and edits a new video or selects and edits an existing video. In this disclosure, the application 146 is described separately from the program 140. However, since the operating system 142 and the middleware 144 are generally regarded as a kind of program that generally controls the electronic device 101, the program 140 may be commonly used without distinction from the application 146 from a narrow point of view. For convenience of description, a computer program that implements a content editing control method for fine adjustment control according to the present disclosure may be referred to as an application 146, and in the present disclosure, the program 140 may be used interchangeably with the application for performing the content editing method from a narrow point of view.

The input device 150 is a device for receiving a command or data to be used in a component (e.g., the processor 120) of the electronic device 101 from the outside (e.g., a user) of the electronic device 101, and may include, for example, a microphone, a mouse or a keyboard.

The audio output device 155 may be a device for outputting a sound signal to the outside of the electronic device 101. For example, the audio output device 155 may include a speaker used for general purposes such as playing multimedia or recording, and a receiver used exclusively for receiving calls. According to one embodiment, the receiver may be formed integrally with or separately from the speaker.

The display device 160 may be a display (or display device) for visually providing information to the user of the electronic device 101. The display device 160 may include, for example, a screen provision device for two-dimensionally displaying an image, a hologram device, or a projector and a control circuit for controlling the device. According to an embodiment, the display device 160 may function not only as an image output interface but also as an input interface for receiving user input. The display device 160 may include, for example, a touch circuitry or a pressure sensor capable of measuring the strength of a touch pressure. The display device 160 may detect the coordinates of a touch input area, the number of touch input areas, a touch input gesture, etc. based on the touch circuitry or the pressure sensor, and transmit the detected result to the main processor 121 or the auxiliary processor 123.

The audio module 170 may convert bidirectionally sound and electrical signals. According to an embodiment, the audio module 170 may obtain sound through the input device 150 or output sound through an external electronic device (e.g., an electronic device 102 (e.g., speaker or headphone)) connected to the electronic device 101 by wire or wirelessly.

The interface 177 may support a designated protocol capable of connecting to an external electronic device (e.g., the electronic device 102) by wired or wirelessly. According to one embodiment, the interface 177 may include a high definition multimedia interface (HDMI), a universal serial bus (USB) interface, an SD card interface, or an audio interface.

A connection terminal 178 is a connector capable of physically connecting the electronic device 101 and the external electronic device (e.g., the electronic device 102), for example, an HDMI connector, a USB connector, an SD card connector, or an audio connector (e.g., headphone connector).

The camera module 180 may capture still images and videos. According to one embodiment, the camera module 180 may include one or more lenses, image sensors, image signal processors, or flashes.

The power management module 188 is a module for managing power supplied to the electronic device 101, and may be configured as at least a part of a power management integrated circuit (PMIC).

The battery 189 is a device for supplying power to at least one component of the electronic device 101, and may include, for example, a non-rechargeable primary battery, a rechargeable secondary battery, or a fuel cell.

The communication module 190 may support establishment of a wired or wireless communication channel between the electronic device 101 and the external electronic device (e.g., the electronic device 102, the electronic device 104, or the server 108) and performance of data communication through the established communication channel. The communication module 190 may include one or more communication processors that support wired communication or wireless communication that are operated independently of the processor 120 (e.g., an application processor). According to an embodiment, the communication module 190 includes a wireless communication module 192 (e.g., a cellular communication module, a short-range wireless communication module, or a global navigation satellite system (GNSS) communication module) or a wired communication module 194 (e.g., a local area network (LAN) communication module or a power line communication module), and, using a corresponding communication module among them, may communicate with the external electronic device through a first network 198 (e.g., a short-range communication network such as Bluetooth, Bluetooth low energy (BLE), Wi-Fi direct, or infrared data association (IrDA)) or a second network 199 (e.g., a long-distance network such as a cellular network, the Internet, or a computer network (e.g., LAN or WAN)). The above-described various types of the communication modules 190 may be implemented as a single chip or may be implemented as separate chips.

Some of the above components may be connected to each other through a communication method between peripheral devices (e.g., a bus, GPIO (general purpose input/output), SPI (serial peripheral interface), or MIPI (mobile industry processor interface)) to exchange signals (e.g., commands or data) with each other.

According to an embodiment, commands or data may be transmitted or received between the electronic device 101 and the external electronic device 104 through the server 108 connected to the second network 199. Each of the electronic devices 102 and 104 may be the same as or different from the electronic device 101. According to an embodiment, at least some of the operations executed in the electronic device 101 may be executed in another or a plurality of external electronic devices. According to an embodiment, when the electronic device 101 needs to perform a specific function or service automatically or upon request, the electronic device 101 may request at least some functions associated with the function or service from the external electronic device instead of or additional to executing the function or service by itself. The external electronic device, which has received the request, may execute the requested function or additional function and deliver the result to the electronic device 101. The electronic device 101 may provide the requested function or service by processing the received result without change or additionally. To this end, for example, cloud computing, distributed computing, or client-server computing technology may be used.

The server 108 may transmit a content editing application according to the request of the electronic device 101 and control the electronic device 101 to implement the application. When the application is executed, the server 106 may exchange data with the electronic device 101, and support the electronic device 101 to perform the content editing method for fine adjustment control according to the present disclosure. In this regard, the server 106 may be a type of computing device according to the present disclosure.

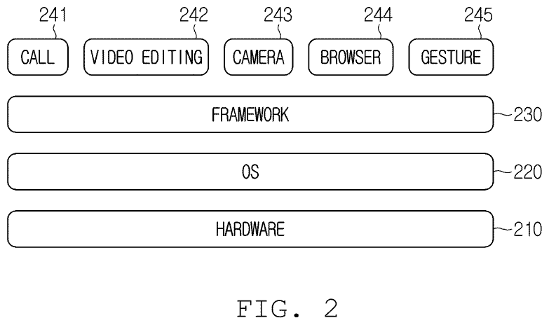

FIG. 2 is a diagram for explaining a system hierarchy structure of an electronic device to which various embodiments of the present disclosure are applied.

Referring to FIG. 2, an electronic device 200 may include a hardware layer 210 corresponding to the electronic device 101 of FIG. 1 described above, and an operating system (OS) layer 220 that manages the hardware layer 210 as a higher layer of the hardware layer 210, a framework layer 230 as a higher layer of the OS layer 220, and application layers 241 to 245.

The OS layer 220 controls overall operations of the hardware layer 210 and performs a function of managing the hardware layer 210. That is, the OS layer 220 is in charge of basic functions such as hardware management, memory, and security. The OS layer 220 may include drivers for operating or driving hardware devices included in the electronic device, such as a display driver for driving a display device, a camera driver for driving a camera module, and an audio driver for driving an audio module. In addition, the OS layer 220 may include a library and a runtime that developers may access.

The framework layer 230 exists as a higher layer of the OS layer 220, and the framework layer 230 serves to connect the application layers 241 to 245 and the OS layer 220. That is, the framework layer 230 includes a location manager, a notification manager, and a frame buffer for displaying an image on the display unit.

The application layers 241 to 245 implementing various functions of the electronic device 101 is located above the framework layer 230. For example, the application layers 241 to 245 may include various application programs such as a call application 241, a video editing application 242, a camera application 243, a browser application 244, and a gesture application 245.

Furthermore, the OS layer 220 may provide a menu or UI capable of adding or deleting at least one application or application program included in the application layers 241 to 245, and through this, at least one application or application program included in the application layers 241 to 245 may be added or deleted by the user. For example, as described above, the electronic device 101 of FIG. 1 may be connected to the other electronic devices 102 and 104 or the server 108 through communication, and may receive data (that is, at least one application or application program) provided from the other electronic devices 102 and 104 or the server 108 by the request of the user and store it in the memory. At this time, at least one application or application program stored in the memory may be configured and operated in the application layers 241 to 245. In addition, at least one application or application program may be selected by the user using the menu or UI provided by the OS layer 220, and the selected at least one application or application program may be deleted.

Meanwhile, when a user control command input through the application layers 241 to 245 is input to the electronic device 101, it may be transferred from the application layers 241 to 245 to the hardware layer 210 to execute a specific application corresponding to the input control command, and the result may be displayed on the display device 160.

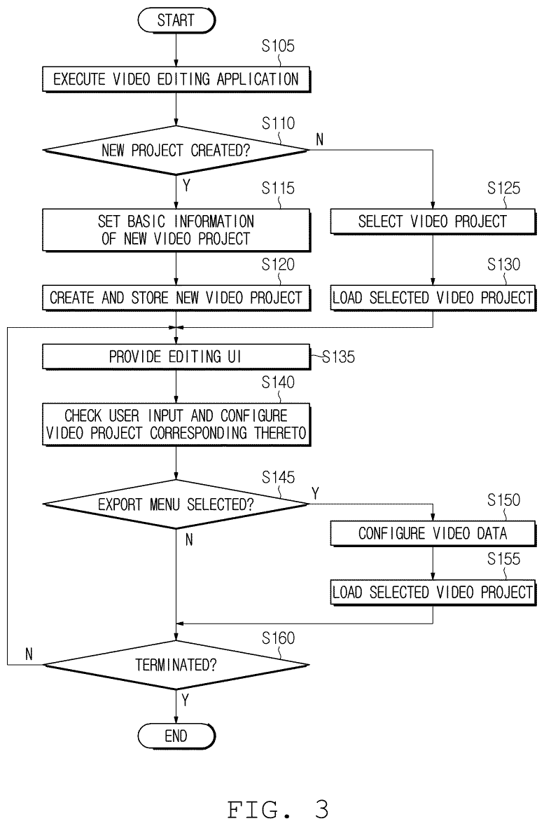

FIG. 3 is a flowchart illustrating a video editing method to which various embodiments of the present disclosure are applied. In FIG. 3, the content editing application is described as a video editing application.

Referring to FIG. 3, first, the video editing method may be operated by the above-described electronic device (or computing device), and the operation may be initiated as a video editing application is selected and executed by user input (S105).

When the video editing application is executed, the electronic device may output an initial screen of the video editing application to a display device (e.g., a display). A menu (or UI) for creating a new video project and a video project selection menu (or UI) for selecting a video project being edited in advance may be provided on the initial screen. On this initial screen, when the menu (or UI) for creating the new video project is selected by the user, the process may proceed to step S115, and when the video project selection menu (or UI) is selected, the process may proceed to step S125 (S110).

In step S115, the electronic device 101 may provide a menu (or UI) for setting basic information of a new video project, and set and apply the basic information input through the menu (or UI) to the new video project. For example, the basic information may include an aspect ratio of the new video project. Based on this, the electronic device may provide a menu (or UI) capable of selecting an aspect ratio such as 16:9, 9:16, 1:1, etc., and an aspect ratio input through the menu (or UI) may be set and applied to the new video project.

Thereafter, the electronic device 101 may create a new video project by reflecting the basic information set in step S115, and store the created new video project in a storage medium (S120).

Although the aspect ratio is exemplified as basic information in embodiments of the present disclosure, the present disclosure is not limited thereto, and may be variously changed by a person having ordinary knowledge in the technical field of the present disclosure. For example, the electronic device 101 may provide a menu (or UI) capable of setting at least one of automatic control of a master volume, the size of the master volume, audio fade-in default setting, audio fade-out default settings, video fade-in default settings, video fade-out default settings, default settings of an image clip, default settings of a layer length or pan & zoom default settings of the image clip, and a value input through the menu (or UI) may be set as the basic information of the new video project.

As another example, the electronic device 101 may automatically set the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip to predetermined values. In addition, the electronic device 101 may provide a setting menu (or UI), receive control values of the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip through the setting menu (or UI), and set the above-described default information according to the received values.

Meanwhile, in step S115, the electronic device 101 may provide a project list including video projects stored in a memory 130 and provide an environment in which at least one video project included in the project list may be selected. Through the above-described environment, the user may select at least one video project included in the project list (S130), and the electronic device 101 may load the at least one video project selected by the user (S135).

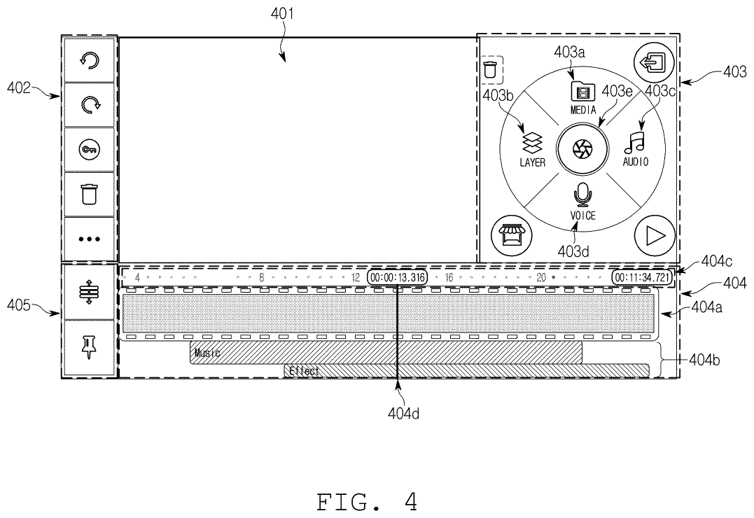

In step S135, the electronic device 101 may provide an editing UI. As shown in FIG. 4, the editing UI may include a video display window 401, a media setting window 402, a media input window 403, a clip display window 404, a clip setting window 405, and the like. In the editing UI, the video display window, the media setting window, and the media input window may be displayed on an upper portion of the display, and the clip display window and the clip setting window may be displayed on a lower portion of the display.

The media setting window may include an export menu, a capture menu, a setting menu, and the like, and the export menu, the capture menu, and the setting menu may be provided in the form of icons or text capable of recognizing the corresponding menu.

The media input window may include a media input menu 403a, a layer input menu 403b, an audio input menu 403c, a voice input menu 403d, a shooting menu 403e, and the like, and the media input menu 403a, the layer input menu 403b, the audio input menu 403c, the voice input menu 403d, and the shooting menu 403e may be provided in the form of icons or text capable of recognizing the corresponding menu. Also, each menu may include a sub-menu, and as each menu is selected, the electronic device 101 may compose and display a sub-menu corresponding thereto.

For example, the media input menu 403a may be connected to the media selection window as a sub-menu, and the media selection window may provide an environment capable of selecting media stored in the memory 130, for example, original media created by the user and received from another source. Media selected through the media selection window may be inserted and displayed in the clip display window. The electronic device 101 may check the type of media selected through the media selection window, set the clip time of the media in consideration of the checked type of the media, insert and display it in the clip display window. Here, the type of media may include images, videos, and the like. If the type of media is an image, the electronic device 101 may check a default length setting value of the image clip and set an image clip time according to the default length setting value of the image clip. In addition, if the type of media is a video, the electronic device 101 may set the time of the video clip according to the length of the corresponding media.

As a sub-menu of the layer input menu 403b, a media input menu, an effect input menu, an overlay input menu, a text input menu, a media input menu, and a drawing input menu may be included.

The media input menu may be configured in the same way as the aforementioned media input menu.

The effect input menu may provide an environment in which blur effect, mosaic effect, noise effect, sandstorm effect, melting point effect, crystal effect, star filter effect, display board effect, haze effect, fisheye lens effect, magnifying lens effect, flower twist effect, night vision effect, sketch effect, etc. may be selected. An effect selected through the effect input menu may be inserted and displayed in the clip display window. At this time, the electronic device may check the default setting value of the layer length and set the effect clip time according to the default setting value of the layer length.

The overlay input menu may provide an environment in which stickers and icons of various shapes or shapes may be selected. The stickers, icons, etc. selected through the overlay input menu may be inserted and displayed in the clip display window. At this time, the electronic device may check the default setting value of the layer length and set the clip times of stickers, icons, etc. according to the default setting value of the layer length.

The text input menu may provide an environment in which text may be input, for example, a Qwerty keyboard. The text input through the text input menu may be inserted and displayed in the clip display window. At this time, the electronic device may check the default setting value of the layer length and set the text clip time according to the default setting value of the layer length.

The drawing input menu may be configured to provide a drawing area in the image display window and to display a drawing object in a touch input area in the image display window. The handwriting input menu may include a drawing tool selection menu for selecting a drawing tool, a color selection menu for selecting a drawing color, a thickness setting menu for setting the thickness of a drawing object, a partial deletion menu for deleting a created drawing object, and a delete-all menu for deleting all drawn objects as sub-menus. In addition, when the handwriting input menu is selected, the electronic device may check the default setting value of the layer length and set the drawing object clip time according to the default setting value of the layer length.

The audio input menu 403c may be connected to the audio selection window as a sub-menu, and the audio selection window may provide an environment in which an audio file stored in a storage medium may be selected. An audio file selected through the audio selection window may be inserted and displayed in the clip display window.

The voice input menu 403d may be a menu for recording sound input through a microphone. When the voice input menu is selected by the user, the electronic device may activate the microphone provided in the device to detect a voice signal input through the microphone. In addition, the electronic device may display a recording start button, and when the recording start button is input, recording of the voice signal may be started. Furthermore, the electronic device may visualize and display the voice signal input through the microphone. For example, the electronic device may check the amplitude or frequency characteristics of the voice signal and display the checked characteristics in the form of a level meter or a graph.

The shooting menu 403e may be a menu for capturing an image or video input through a camera module included in the electronic device 101. The shooting menu 403e may be displayed through an icon visualizing a camera device. The shooting menu 403e may include an image/video shooting selection menu for selecting a camera for capturing an image or a camcorder for capturing a video as a sub-menu thereof. Based on this, when the shooting menu 403e is selected by the user, the electronic device may display an image/video shooting selection menu. In addition, the electronic device may activate an image capturing mode or a video capturing mode of the camera module according to selection through the image/video capturing selection menu.

The clip display window 404 may include at least one clip line displaying a clip corresponding to media, effect, overlay, text, drawing, audio, voice signal, etc. input through the media input window.

The clip line may include a main clip line 404a and a sub clip line 404b, and a clip line provided at the uppermost end of the clip display window is referred to as the main clip line 404a, and at least one clip line provided under the main clip line 404a may be referred to as the sub clip line 404b.

The electronic device may fix and display the main clip line 404a at the uppermost end of the clip display window, check drag input based on an area where the sub clip line 404b exists, and scroll the sub clip line 404b up and down according to a drag input direction.

Furthermore, when the drag input direction is checked as an upward direction, the electronic device 101 may move and display the sub clip line 404b to an upper area, and when the drag input direction is checked as a downward direction, the electronic device may move and display the sub clip line 404b to a lower area. In addition, the electronic device may display the height of the main clip line 404a differently according to the movement of the sub clip line 404b. For example, when the sub clip line 404b moves upward, the height of the main clip line 404a may be decreased and displayed, and when the sub clip line 404b moves downward, the height of the main clip line 404a may be increased and displayed.

In particular, the clip display window 404 may include a time display line 404c indicating the time of the video project and a play head 404d. The time display line 404c may be displayed above the main clip line 404a described above, and may include a scale or number in a predetermined unit. In addition, the play head 404d may be displayed as a line starting from the time display line 404c and vertically connected to the lower end of the clip display window, and may be displayed in a color (e.g., red) that can be easily recognized by the user.

Furthermore, the play head 404d may be provided in a fixed form in a predetermined area, and the objects included in the main clip line 404a and the sub clip line 404b provided in the clip display window and the time display line 404c may be configured to be movable in the left and right directions.

For example, when drag input is generated in the left and right directions in an area where the main clip line 404a, the sub clip line 404b, and the time display line 404c are located, the electronic device may move and display the objects included in the main clip line 404a and the sub clip line 404b and the time display line 404c in the left and right directions. In this case, the electronic device may be configured to display a frame or object corresponding to the play head 404d in the image display window. In addition, the electronic device 101 may check a detailed time (e.g., in units of 1/1000 second) that the play head 404d touches, and display the checked detailed time together in the clip display window.

In addition, the electronic device 101 may check whether a multi-touch has occurred in the clip display window 404, and if a multi-touch has occurred, a scale or number of a predetermined unit included in the time display line 404c may be changed and displayed in response to the multi-touch. For example, when input in which a multi-touch interval gradually decreases is confirmed, the electronic device may decrease the interval between scales or numbers. When input in which the multi-touch interval gradually increases is confirmed, the electronic device may increase and display the interval between scales or numbers.

The electronic device may configure the clip display window 404 so that a clip displayed on the clip line may be selected, and when a clip is selected, it may visualize and display that the corresponding clip has been selected. For example, when selection of a clip is detected, the electronic device may provide a clip selector to a boundary of the selected clip, and the clip selector may be displayed in a predetermined color, for example, yellow.

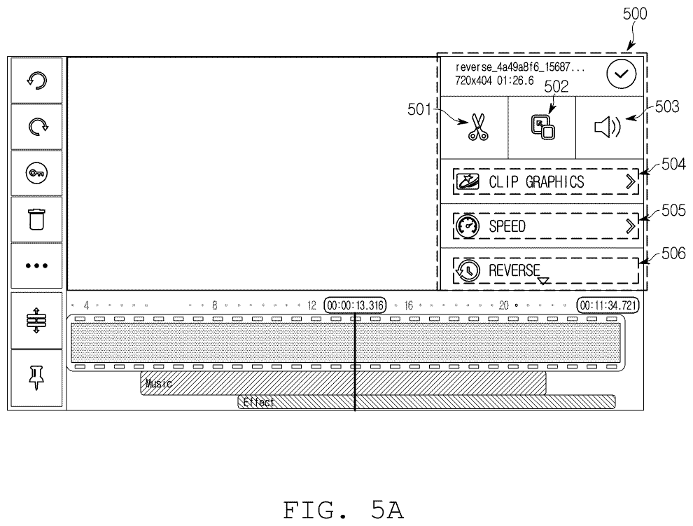

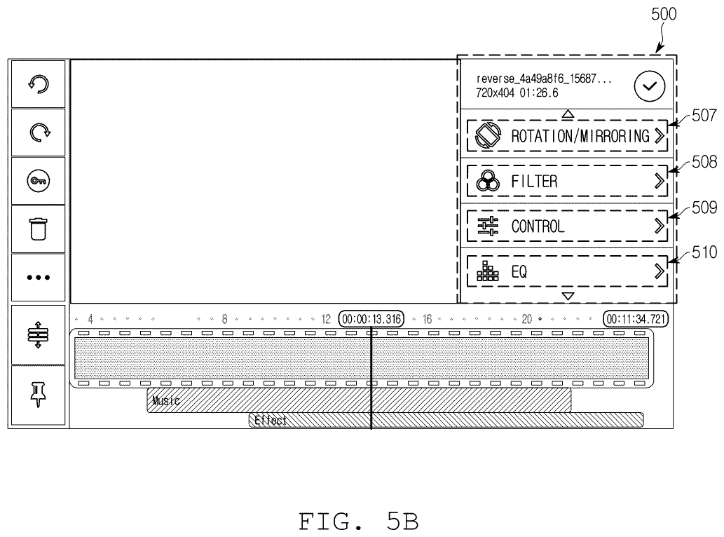

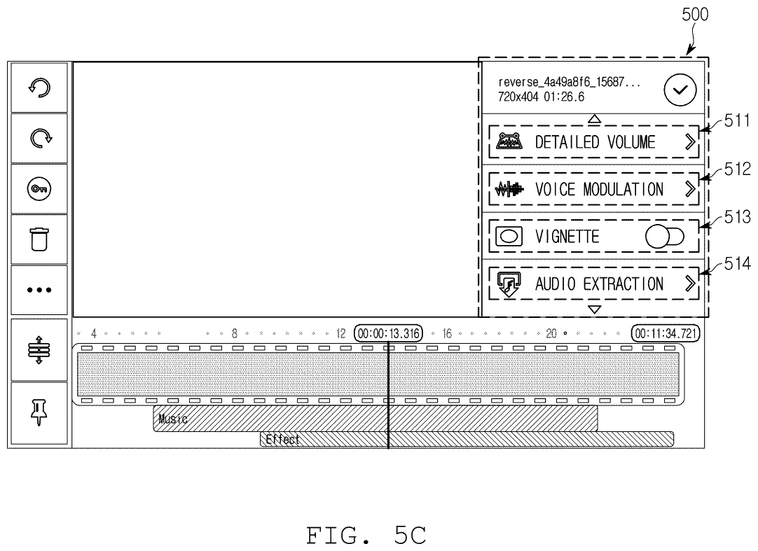

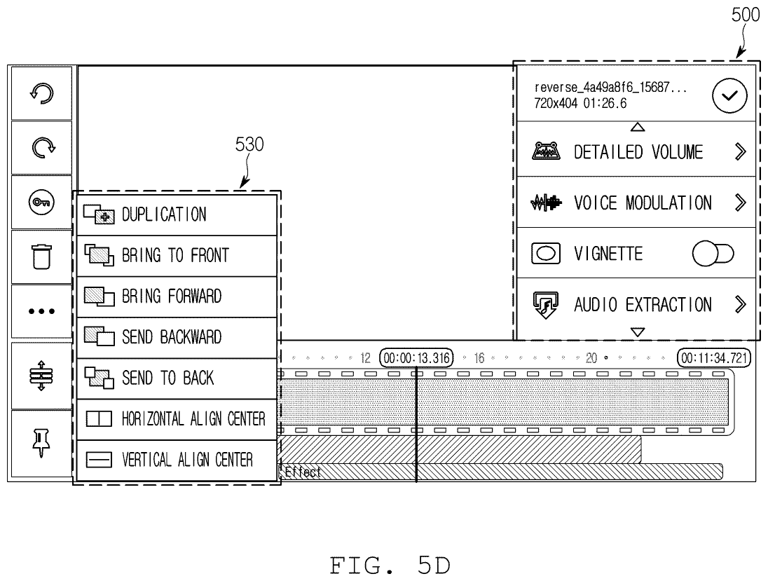

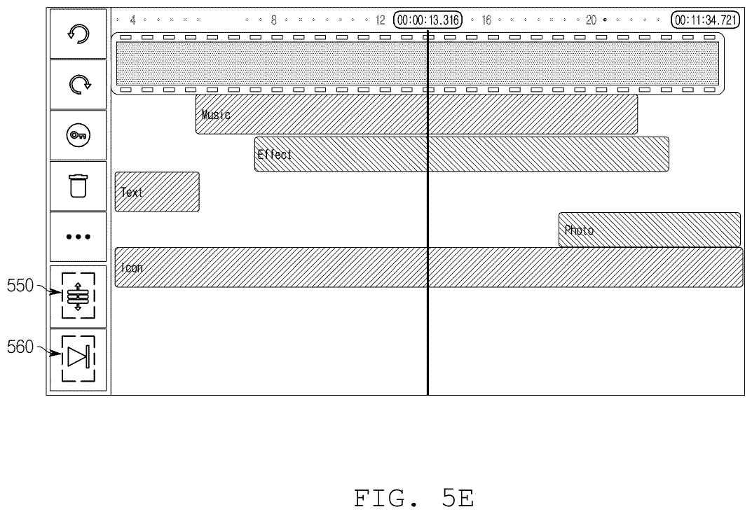

Preferably, when selection of a clip is detected, the electronic device may provide a clip editing UI capable of editing the selected clip. For example, the electronic device may display a clip editing UI in an area where the media input window 403 exists, as shown in FIGS. 5a to 5d. The clip editing UI may be set differently according to the type of the selected clip. Specifically, when the type of clip is a video clip, the electronic device may configure and provide a clip editing UI 500, by including a trim/split menu 501, a pan/zoom menu 502, an audio control menu 503, a clip graphic menu 504, and a speed control menu 505, a reverse control menu 506, a rotation/mirroring control menu 507, a filter menu 508, a brightness/contrast control menu 509, a voice EQ control menu 510, a detailed volume control menu 511, a voice modulation menu 512, a vignette control menu 513, an audio extraction menu 514, and the like.

The clip editing UI for each type of clip may be configured based on the structure of the video editing UI.

Additionally, the electronic device 101 may further display a clip editing expansion UI 530 in an area where the media setting window exists. The clip editing expansion UI displayed in the area of the media setting window may also be set differently according to the type of the selected clip. For example, when the type of clip is a video clip, an image clip, an audio clip, or an audio signal clip, the electronic device may configure and provide the clip editing expansion UI 530 by including a clip deletion menu, a clip duplication menu, a clip layer duplication menu, and the like. If the type of clip is a video clip, image clip, audio clip, or audio signal clip, the electronic device may configure and provide the clip editing expansion UI 530 by including the clip deletion menu, the clip duplication menu, the clip layer duplication menu, and the like, and if it is an effect clip, text clip, overlay clip, or drawing clip, the electronic device may configure and provide the clip editing expansion UI by including a clip deletion menu, a clip duplication menu, a bring-to-front menu, a bring-forward menu, a send-backward menu, a send-to-back menu, a horizontal align center menu, a vertical align center menu and the like.

The clip setting window may include a clip enlargement display menu 550 and a clip movement control menu 560, as shown in FIG. 5e. When the clip display menu 550 is selected by the user, the electronic device may enlarge and display the clip display window to the entire area of the display. Also, when the clip movement control menu 560 is selected, the electronic device may move and display the clip according to the play head. Furthermore, the clip movement control menu 560 may include a start area movement menu or an end area movement menu, and it is preferable that the start area movement menu or end area movement menu may be adaptively displayed in consideration of the position of the play head touching the clip. For example, the electronic device basically provides the start area movement menu, and when a clip touches a starting position of the play head, the start area movement menu may be replaced with the end area movement menu and displayed.

In step S140, the electronic device may check user input input through the editing UI, configure a video project corresponding to the user input, and store the configured video project in a storage medium.

As described above, the editing UI is configured to include an export menu in the media setting window. When the export menu is selected by the user (Y in S145), the electronic device 101 may configure video data by reflecting the information configured in the video project and store it in a memory 130 (S150).

In addition, the electronic device 101 may upload the edited video and project to a shared video service-related device according to the request of a user at the same time as or after the video data is stored through the export menu.

The structure of the editing UI provided by the apparatus for controlling the video editing UI according to various embodiments of the present disclosure may be configured as follows.

First of all, as shown in FIG. 4, the editing UI may basically include a video display window 401, a media setting window 402, a media input window 403, a clip display window 404, a clip setting window 405, and the like. At least one clip selected through the media input window 403 may be displayed on the clip display window 404. In addition, as at least one clip 404a or 404b included in the clip display window 404 is selected, as shown in FIGS. 5a to 5d, clip editing menus 501 to 514 may be provided in the area where the media input window 403 exists. At this time, the clip editing menus 501 to 514 may be provided adaptively according to the structure of the editing UI for each clip type.

The video clip editing menu may include a trim/split menu, a pan/zoom menu, an audio control menu, a clip graphic menu, a speed control menu, a reverse control menu, a rotation/mirroring menu, a filter menu, a brightness/contrast/gamma control menu, a voice EQ control menu, a detailed volume control menu, a voice modulation control menu, a vignetting ON/OFF control menu, an audio extraction menu, and the like.

The trim/split menu may include a trim menu on the left of the play head, a trim menu on the right of the play head, a split menu on the play head, a still image split and insert menu, and the like, as sub-menus.

The audio control menu may include a master volume control bar, a sound effect volume control bar, an automatic volume ON/OFF menu, a left/right balance control bar, a pitch control bar, and the like, as sub-menus. In addition, the master volume control bar, the sound effect volume control bar, the left/right balance control bar, the pitch control bar, and the like may be set to support a detailed control UI, and the master volume control bar, the sound effect volume control bar, the left/right balance control bar, the pitch control bar and the like may be managed through the main editing UI. A UI set as the main editing UI may be configured to display a detailed control UI together. As another example, when touch input is generated for more than a predetermined time (e.g., 1 second) in an area where the main editing UI set to support the detailed control UI exists, the detailed control UI may be activated as a sub-menu.

The clip graphic menu may be configured to select at least one graphic to be inserted into the clip.

The speed control menu may include at least one predetermined speed control button (e.g., 1×, 4×, 8×), a speed control bar, a mute ON/OFF menu, a pitch maintenance ON/OFF menu, and the like. Also, the speed control bar may be managed as a main editing UI.

The reverse control menu may be configured to perform reverse processing of a video included in a corresponding clip.

The voice EQ control menu may be configured to select at least one voice EQ to be applied to a video.

The filter menu may be configured to select at least one video filter to be applied to the video.

The brightness/contrast/gamma control menu may include a brightness control bar, a contrast control bar, a gamma control bar and the like as sub-menus so as to control the brightness/contrast/gamma value of the video, and the brightness control bar, the contrast control bar, and the gamma control bar and the like may be managed as a main editing UI and set to support the detailed control UI.

The rotation/mirroring menu may include a horizontal mirroring menu, a vertical mirroring menu, a counterclockwise rotation menu, a clockwise rotation menu and the like as sub-menus, and the counterclockwise rotation menu and clockwise rotation menu may be managed as a main editing UI and set to support the detailed control UI.

The detailed volume control menu is a menu for controlling the volume of audio included in the video, and may include a control point addition menu, a control point deletion menu, a voice control bar and the like. The voice control bar may be managed as a main editing UI and set to support the detailed control UI.

The voice modulation control menu may be configured to select at least one voice modulation method to be applied to the video.

Meanwhile, the image clip editing menu may include a trim/split menu, a pan/zoom menu, a rotation/mirroring control menu, a clip graphic menu, a filter menu, a brightness/contrast/gamma control menu, a vignetting ON/OFF control menu, and the like.

In addition, the effect clip editing menu may include an effect setting menu, a transparency control menu, a trim/split menu, a rotation/mirroring control menu, and the like, and the trim/split menu, the rotation/mirroring control menu and the like may be configured similarly to the video clip editing menu. In addition, the effect setting menu and the transparency control menu may include an effect setting bar and a transparency control bar, respectively, as sub-menus, and the effect setting bar and the transparency control bar may be managed as a main editing UI and set to support the detailed control UI.

The overlay clip editing menu may include an overlay color setting menu, a transparency control menu, a trim/split menu, a rotation/mirroring control menu, a blending type setting menu, and the like. The trim/split menu, the rotation/mirroring control menu and the like may be configured similarly to the video editing menu. Also, the transparency control menu may include a transparency control bar as a sub-menu, and the transparency control bar may be managed as a main editing UI and set to support the detailed control UI.

In addition, the text clip editing menu may include a text font setting menu, a text color setting menu, a trim/split menu, a transparency control menu, a rotation/mirroring control menu, a text alignment method setting menu, a shadow ON/OFF menu, a glow ON/OFF menu, an outline ON/OFF menu, a background color ON/OFF menu, a blending type setting menu, and the like, and the trim/split menu, the transparency control menu, the rotation/mirroring control menu, and the like may be configured similarly to the video clip editing menu. In addition, the shadow ON/OFF menu, the glow ON/OFF menu, the outline ON/OFF menu, and the background color ON/OFF menu may respectively include a color control bar (e.g., R/G/B control bar) for setting a color or a transparency control bar for controlling transparency as sub-menus, and the color control bar (e.g., R/G/B control bar) or the transparency control bar may be managed as a main editing UI and set to support the detailed control UI.

In addition, the drawing clip editing menu may include a transparency control menu, a trim/split menu, a rotation/mirroring control menu, a blending type setting menu, and the like, and the trim/split menu, the rotation/mirroring control menu and the like may be configured similarly to the overlay clip editing menu. Also, the transparency control menu may include a transparency control bar as a sub-menu, and the transparency control bar may be managed as a main editing UI and set to support the detailed control UI.

In addition, the audio clip editing menu may include an audio control menu, a voice EQ control menu, a detailed volume control menu, a voice modulation control menu, a ducking ON/OFF control menu, a repeat ON/OFF control menu, a trim/split menu, and the like. The audio control menu, the voice EQ control menu, the detailed volume control menu, the voice modulation control menu, the trim/split menu, and the like may be configured similarly to a video clip editing menu.

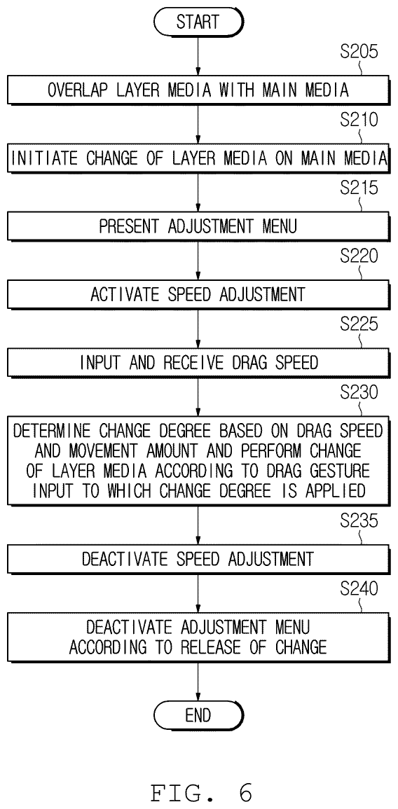

Hereinafter, a content editing control method for fine adjustment control according to various embodiments of the present disclosure will be described with reference to FIGS. 6 to 10D.

First, objects and object changes related to the method according to the present disclosure will be described in detail.

An object may be a media object or an editing tool that edits the media object. The object is provided to the display 160 of the electronic device 101, and the change of the object may be performed by an editing interface provided on the display to receive touch input of a user. The editing interface may include not only an editing tool, but also an area of the media object where change control is processed by touch input, and all part interfaces associated with the media object and where change control according to touch input is processed.

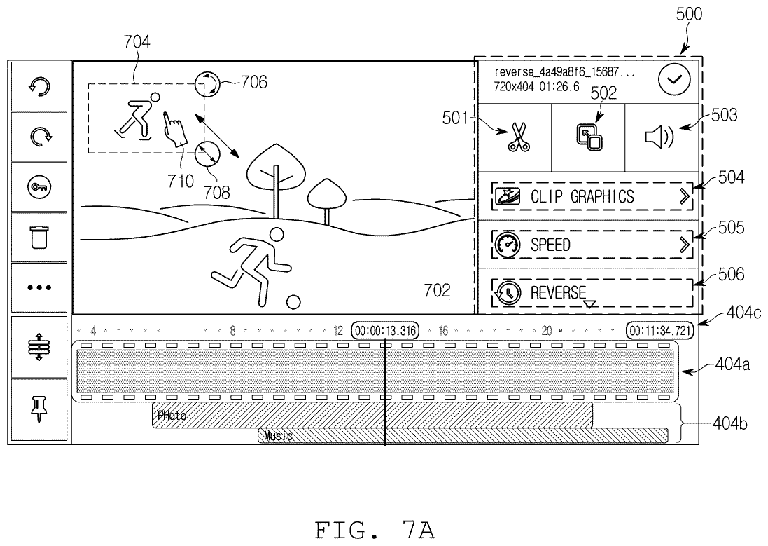

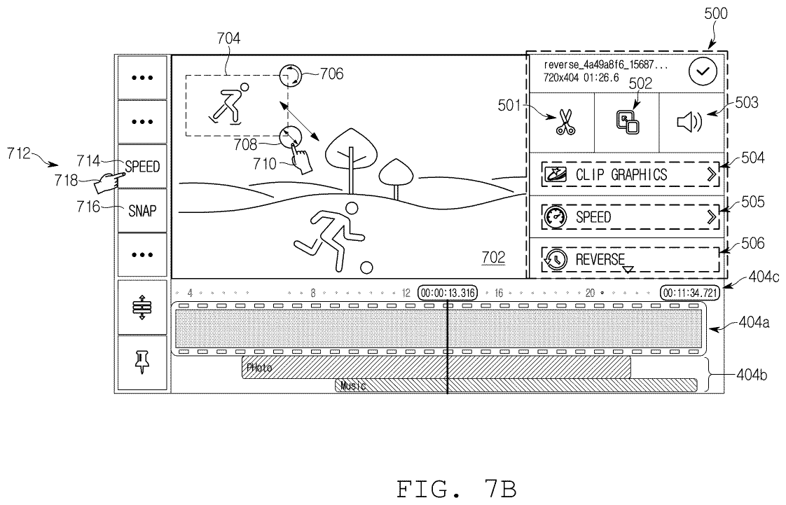

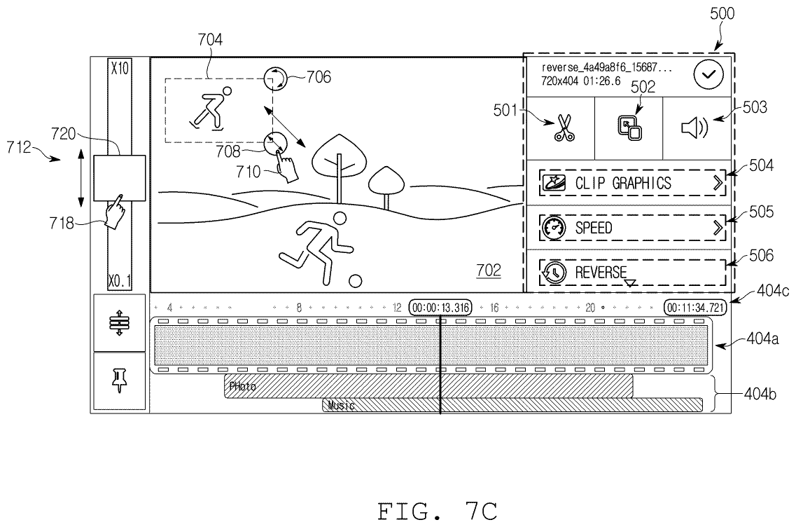

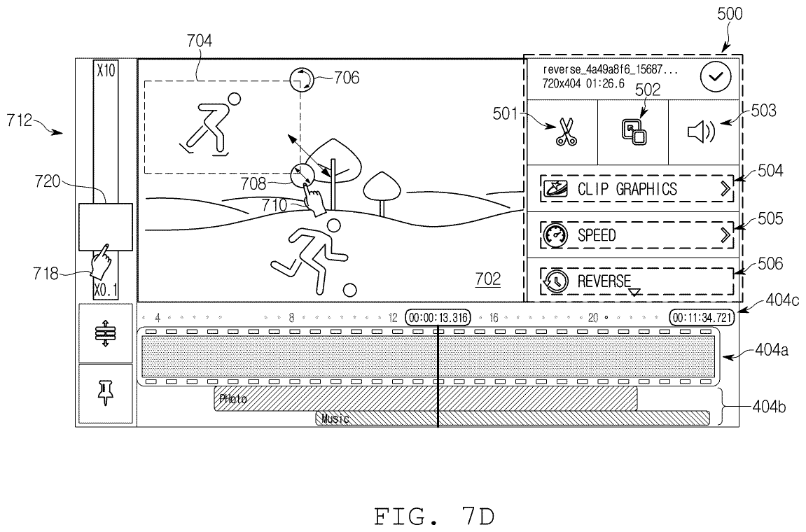

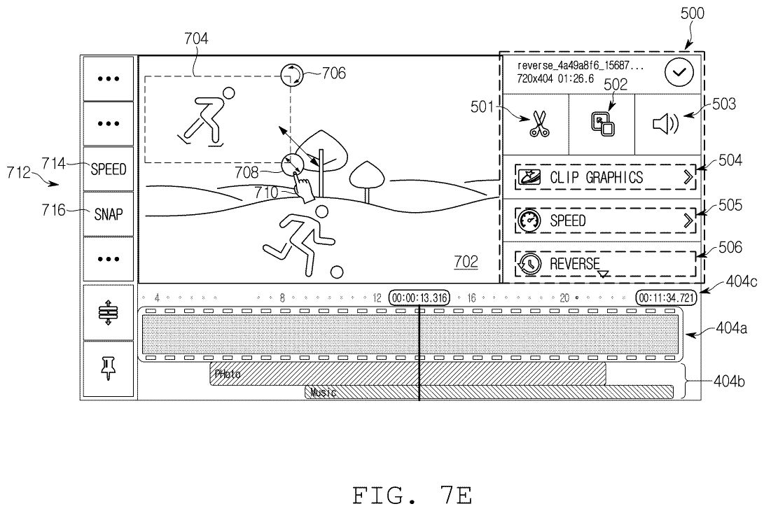

Regarding the media object, the object may be main media 702 displayed in the video display window 401 or layer media 704 that overlaps it, as illustrated in FIG. 7A. The main media 702 may be a still image or video. The layer media is a layer overlapping the main media and may be, for example, a video frame, voice, effect, image frame, text, etc. In the present disclosure, the main media 702 may be used interchangeably with a main media object, a main layer object, and a main layer. In addition, in the present disclosure, the layer media may be used interchangeably with a layer media object, a sub media object, an overlap layer object, and an overlap layer.

Specifically, the input of the layer media object 704 may include a media input menu 403a, a layer input menu 403b, an audio input menu 403c, a voice input menu 403d, and a shooting menu 403e. The layer media 704 created according to the input is content mentioned in the media input menu 403a, the layer input menu 403b, the audio input menu 403c, the voice input menu 403d, and the shooting menu 403e, and may be additional content that decorates the main layer 702.

Media and shooting may be images, videos, etc. that have been previously stored or taken. Effects may be blur effect, mosaic effect, noise effect, sandstorm effect, melting point effect, crystal effect, star filter effect, display board effect, haze effect, fisheye lens effect, magnifying glass lens effect, flower twist effect, night vision effect, sketch effect, etc. In addition, an overlay may be stickers or icons in various forms or shapes, and a drawing may be a drawing object that may be created in a drawing area that is touch-input in the video display window. Audio and voice may be a pre-stored audio file or a voice acquired from a microphone of an electronic device.

The layer media 704 may be temporally and spatially arranged and combined, thereby creating content. In addition, the layer media 704 may be arranged and combined by overlapping in a depth direction at the same time and in a two-dimensional space, and in this case, depth information between the elements may be included. The arrangement combination of the above-described elements may be referred to as a relationship between the elements of content in this specification.

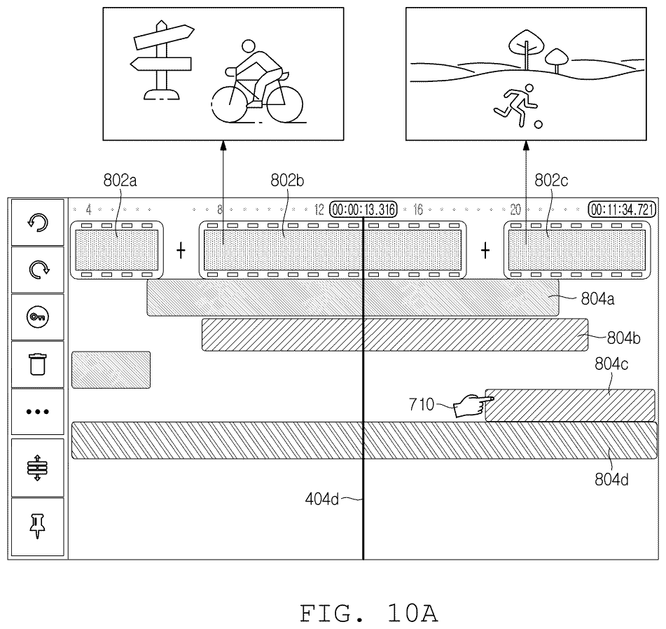

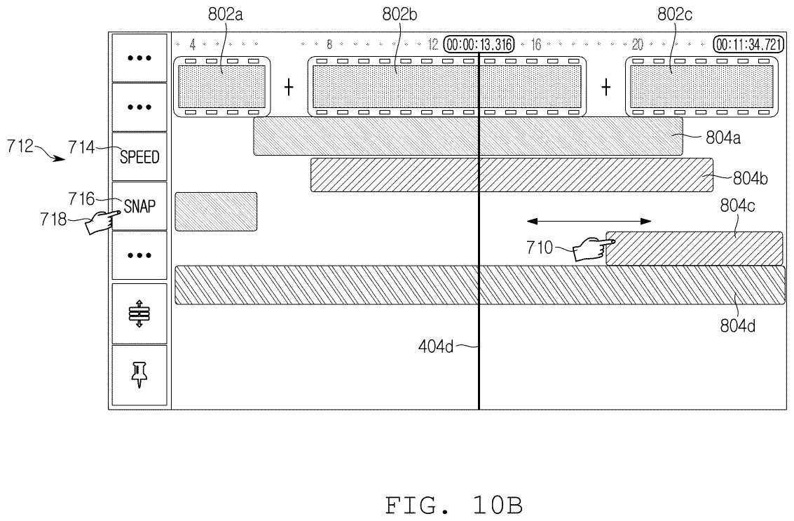

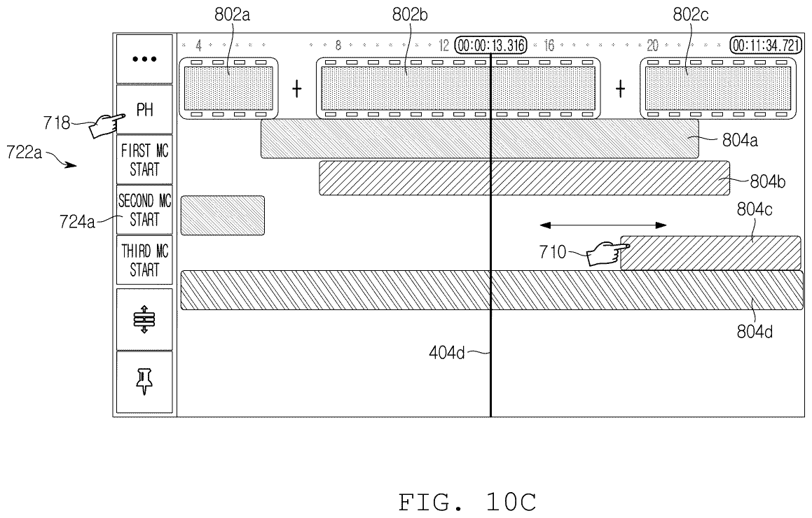

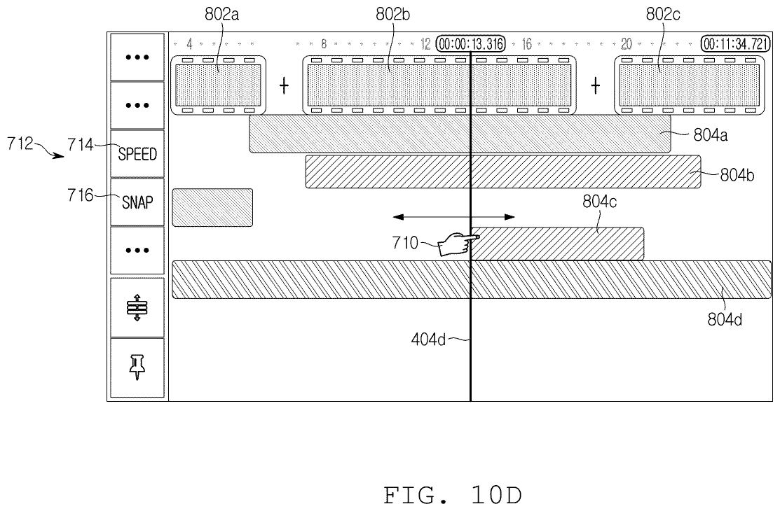

As another example, the objects may be clips 404a and 404b provided in relation to each media in the clip display window 404 so that the main media 702 and the layer media 704 may be briefly checked in time series. For example, the clip may include the main clip 404a related to the main media 702 and the sub clip (or layer clip) 404b related to layer media 704. Additionally, for example, in FIG. 10A, which will be described later, the clip display window 404 may display first to third main clips 802a to 802c corresponding to first to third main media and first to fourth sub clips (or layer clips) 804a to 804d corresponding to the layer media in time series. In addition, when determining a point at which the effect element provided by the video editing application is applied to each media, the object may be an effect element. The effect element may be, for example, in-animation included in the media, clip graphics such as background graphics, filters that give the mood of the media, etc., and are not limited to the examples described above and may include various examples.

Unlike the layer media 704, the effect element may not be applied to each media and created as separate clips in the clip display window 404. Specifically, when the effect element is provided to the main media 702, the application point of the effect element may be determined by specifying the start and/or end point on the main clip 404a of the clip display window 404.

As another example, the object may be an editing tool that may change the attribute value of the object according to a user's adjustment instruction among the content editing tools implemented in the electronic device of FIGS. 4 to 5E. The editing tool may be fine-adjusted by, for example, a user's drag gesture to change the attribute value to a desired setting value. The editing tool includes, for example, the baseline 404d of the clip display window 404 shown in FIG. 4, a scroll bar for speed 505 shown in FIG. 5A, a scroll bar for brightness, chroma, image mood as detailed adjustment item of adjustment 509 shown in FIG. 5, and a transparency adjustment scroll bar (not shown). The editing tool is not limited to the above-described example, and may include various editing interfaces provided to edit the main and layer media 702 and 704 in the video editing application and the input menus 403a to 403e shown in FIGS. 4 to 5E or to apply various effects.

The change of the object may be a change which occurs in media, clip, effect element or editing tool, by adjustment according to touch input of the user. For example, the change of the object may be a change in form of the main media or the layer media overlapping it. The change in form may be free position movement, free rotation, size change, pinch-zoom, or pinch-rotation of the media in the video display window 401. As another example, the change of the object may include precise movement of the clips 404a and 404b in the clip display window 404, control of the effect element within the clip to specify an application point of the effect element applied to the media, or adjustment of the editing tool capable of changing the attribute value of the object. The above-described control and change are realized using, for example, a drag interface for an object change provided in the video editing application, and precise change may be implemented by the drag gesture of the user.

As another example, the change of the object may be a change in which a change that occurs in a media, clip, or effect element by user's adjustment is performed based on a previously determined alignment reference object. There may be one or a plurality of alignment reference objects, and if there are a plurality of alignment reference objects, the change of the object may be realized based on the object selected by the user. For example, in the case of the layer media 704, the alignment reference object may be a virtual guide line or a grid in the form of a virtual matrix on the main media 702. At least one guide line may be displayed on the main media 702, and the user may move the position of the layer media 704 to align the layer media 704 with the guide line. Similarly, the user may move the position of layer media 704 to align the layer media 704 with one of the discrete grid lines. Taking a clip change as an example, the alignment reference object may be a point (e.g., start or end point) of another clip with which a point of a specific clip is aligned. For example, when detecting movement of a specific clip through a drag gesture in the clip display window 404, the processor 120 may determine the above-mentioned points as alignment reference objects. Even in the case of effect elements, each point of all clips with which one point of the effect element may be aligned may be used as an alignment reference object. This method may be similarly applied to the editing tool.

FIG. 6 is a flowchart of a content editing control method for fine adjustment control according to an embodiment of the present disclosure. FIGS. 7A to 7E are diagrams illustrating a process of implementing a content editing method according to an embodiment of the present disclosure. The embodiment of FIG. 6 may be performed, for example, as detailed processes of steps S135 and S140 of FIG. 3.

In the present disclosure, it is assumed that objects are the main media 702 and the layer media 704, and an object to be changed is the layer media 704. In addition, using a video editing application, a user may select original media as an editing target and perform initial editing, or select a video project of pre-edited content and subsequently edit media related to the edited content. Hereinafter, for convenience of description, an example in which after the video project of pre-edited content is loaded, the user uses the editing interface provided on the display 160 to overlap the layer media 704, change it, and additionally edit other content will be described. Of course, the operations and functions described below may be applied even when the user uploads original media and edits it for the first time.

As illustrated in FIG. 7A, the processor 120 may call the video project according to the user's request and load the pre-edited main media 702 and the corresponding main clips 802a to 802c into the video display window 401 and the clip display window 404, respectively.

Subsequently, as illustrated in FIG. 7A, the processor 120 may control the original media selected as the layer media 704 to overlap a predetermined portion of the main media 702 according to the user's request, and provide the sub clips 804a to 804d of the layer media 704 to the clip display window 404 (S205).

Next, the processor 120 may detect predetermined input 710 for the user's layer media 704 received by the display 160 and detect initiation of the change of the layer media 704 (S210).

The change of the layer media 704 may detect a change in the shape of the layer media 704 on the main media 702, for example, through a user's gesture using a layer interface or a pointing device (not shown; for example, a mouse).

The layer interface may be an editing interface that receives a user's request to change the layer media 704. The layer interface may be provided in a preset area of the layer media 704. For example, as shown in FIG. 7A, the layer interface may include a layer rotation input unit 706 for rotation of the layer media 704, a layer size input unit 708 for size change, and a position movement input unit (not shown) that receives a user's drag gesture to change the position of the layer media 704 on the main media 702.

The user may perform an input to the layer interface, for example, a drag gesture, to perform a desired shape change, and the processor 120 may detect the drag gesture. The drag gesture may be implemented by the user through touch input on the display device 160, or may be implemented using a pointing device (not shown; for example, a mouse).

In the example of FIG. 7A to 7E, it is assumed that the predetermined input is touch input to the display 160, and the layer media 704 is enlarged with the first touch input 710 to the layer size input unit 708. In the above example, the first touch input 710 is a drag gesture that expands the layer size input unit 708 to the outside of the layer media 704.

Next, upon detecting the initiation of the change of the layer media 704, the processor 120 may provide an adjustment menu 712 (or fine adjustment menu, hereinafter referred to as ‘adjustment menu’ for convenience) according to the type of object change to the display 160 (S215).

Specifically, the processor 120 may provide the adjustment menu 712 when determining that the change is initiated and the change input continues. As illustrated in FIG. 7B, when the processor 120 may display the adjustment menu 712 when determining that the first touch input 710 related to the expansion of the layer media 704 by the layer size input unit 708 is continuously performed and maintained.

The adjustment menu 712 may provide adjustment control types 714 and 716 depending on the type of object change. The adjustment control types 714 and 716 are matched for each type of object change, so that the processor 120 may present adjustment control types 714 and 716, such as function button keys, etc., based on the type of object change. In the example of FIG. 7B, the processor 120 may determine that the type of object change is a size change of the layer media 704 through the layer size input unit 708, and present a speed adjustment activation key 714 and a snap activation key 716 as the adjustment control types 714 and 175 matching the type. The speed adjustment activation key 714 may provide the adjustment item related to the function of adjusting the processing speed for input of the object change. The snap activation key 716 may provide the adjustment item related to an automatic alignment function based on a predetermined alignment reference object and input of the object change. In the example of FIG. 7B, the speed adjustment activation key 714 may provide the adjustment item related to processing speed according to the drag gesture. The adjustment item may be, for example, the speed adjustment key 720 shown in FIG. 7C. The processing speed may be, for example, an expansion distance or ratio of the layer media 704 according to the distance of the drag gesture. In the example of FIG. 7B, when an alignment reference object such as a guide line or grid is displayed on the main media 702, the snap activation key 716 may provide the adjustment item related to at least one alignment reference object capable of automatic alignment.

Then, when the user selects the speed adjustment activation key 714 as the adjustment control type through the second touch input 718, the processor 120 may provide the speed adjustment key 718 to the display 160, as illustrated in FIG. 7C (S220).

The speed adjustment key 720 may provide the adjustment item including a range from a value smaller than a default value to a larger value based on the default value according to the drag gesture. In addition, the speed adjustment key 720 may be set to have an initial value as the default value.

In FIG. 7C, the speed adjustment key 720 is illustrated as a sliding interface, but the speed adjustment key 720 may be expressed by various types of interfaces. In addition, in the present disclosure, the speed adjustment key 720 is described as being displayed by generating the second touch input 718 while the first touch input 710 is maintained. However, in another example, even if the first touch input 710 is released, the speed adjustment key 720 may be displayed.

Next, the user may input the drag speed through the speed adjustment key 718 while maintaining the first touch input 710 for desired shape change, and the processor 120 may receive the input drag speed information (S225).

Taking FIG. 7D as an example, in order to precisely adjust the size of the layer media 704, when the user changes and inputs the drag speed through the scroll of the speed adjustment key 718 while maintaining the first touch input 710 of the layer media 7904, the processor 120 may receive drag speed information.

In this example, a drag speed having a value smaller than the default value is selected as an adjustment item, so the speed of the drag gesture (i.e., the first touch input 710) for expanding the size of the layer media 704 is reduced, and the object change related to the size expansion may be precisely controlled. Unlike the example of FIG. 7D, the user may select a drag speed having a value larger than the default value, thereby increasing the speed of the drag gesture. In this case, the layer media 704 may quickly expand with a movement amount greater than an actual distance according to the drag gesture.

Next, the processor 120 may determine the shape change degree according to the drag speed information and the movement amount of the drag gesture (first touch input 710), and perform the shape change of the layer media according to the drag gesture input to which the shape change degree is applied (S230).

Specifically, the processor 120 may control object change according to the user's instruction based on drag speed information specified by the user as an adjustment item. The object change according to the user's instruction may be changed to expand the layer media 704 by drag gesture input using the layer size input unit 708, as illustrated in FIG. 7D.

In relation to the shape change degree, for example, the shape change degree according to the size of the layer media 704 may be set to a product of the drag movement amount of the layer size input unit 708 received through the first touch input 710 and the drag speed information received through the second touch input 718. If the drag speed information is set to 0.1, even if the user actually manipulates the movement amount of 10 with the drag gesture (first touch input 710), the drag gesture input to which the shape change degree is applied may be applied as 1 (=10*0.1). In contrast, if the drag speed information is set to 10, even if the user actually manipulates the drag with the movement amount of 1, the drag gesture input to which the shape change degree is applied may be applied as 10 (=1*10).

Therefore, when the drag speed information is set to 0.1, even if the movement amount of the drag related to the size change of the user is somewhat excessive, the processor 120 does not change the size of the layer media 704 by reflecting the entire movement amount, and may change the size of the layer media 704 with the reduced ratio compared to the movement amount, according to the shape change degree based on the movement amount and the drag speed information. Accordingly, the size change of the layer media 704 may be precisely controlled.

FIG. 7D shows processing of a precise change in size according to the first touch input 710 in a state in which the second touch input 718 specifying the drag speed is maintained, which will be focused upon in the present disclosure. As another example, even if the second touch input 718 is released, the precise change according to the first touch input 710 may be processed.

Next, if the user deactivates the speed adjustment function, the processor 120 may not provide the speed adjustment key 718 to the display 160 (S235).

Deactivation of the speed adjustment function may be implemented, for example, by the user releasing the second touch input 718 from the speed adjustment key 718 or turning it off using a separate method, as illustrated in FIG. 7E. By deactivating the speed adjustment function, the processor 120 may restore the drag speed information to the default value, and after restoration, the input of the drag gesture according to the first touch input 710 may be set based on the default value and the drag movement amount. The shape change of the object change may also be performed by a drag gesture that reflects the default value.

Next, if the user releases the shape change, the processor 120 may deactivate the adjustment menu 712 (S240).

The release of the shape change may occur, for example, when the user ends the first touch input 710 to the layer size input unit 708. Therefore, the processor 120 may interrupt the adjustment menu 712 which provides adjustment activation keys such as the speed adjustment activation key 714 and the snap activation key 716 on the display 160. The editing interface related to the interrupted example may be implemented by the screen in FIG. 7A.

In the present embodiment, the precise shape change of the media will be focused upon, but it is applicable to precise movement of clips (802a to 802c and 804a to 804d of FIG. 10A) in the clip display window, precise control of the effect element within the clip for specifying the application point of the effect element applied to the media or precise adjustment of the editing tool capable of changing the attribute value of the object. In addition, the present embodiment is applicable to all situations requiring precise adjustment of the object change in the video editing application, for example, a situation where a fine drag gesture is required for object change.

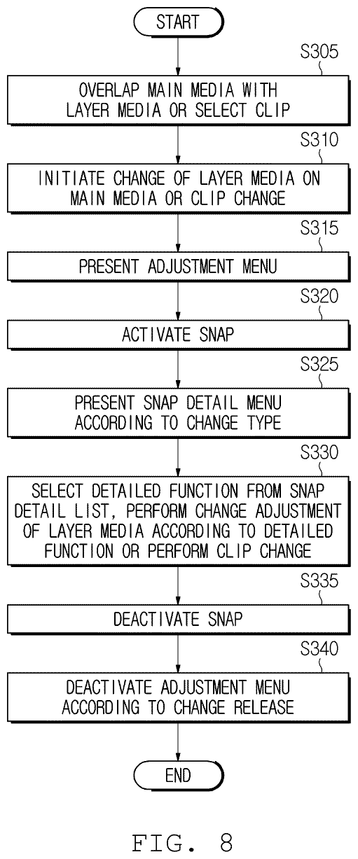

FIGS. 8 to 10D illustrate embodiments related to a media change or a clip change according to a pre-set alignment reference object. The present embodiments relate to a snap function that automatically aligns to an alignment reference object. In the present disclosure, functions and processes that are substantially the same as those in FIGS. 6 to 7E will be omitted or abbreviated.

FIG. 8 is a flowchart of a content editing control method for fine adjustment control according to another embodiment of the present disclosure. The embodiment of FIG. 8 may be performed, for example, as detailed processes of steps S135 and S140 of FIG. 3.

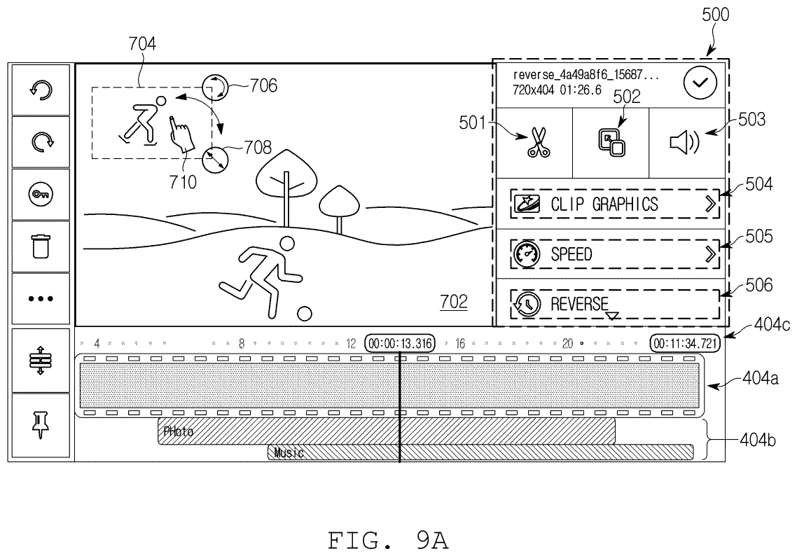

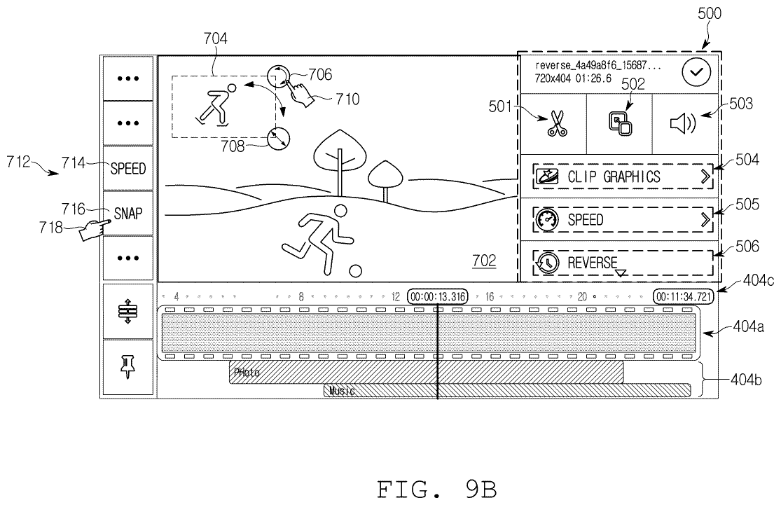

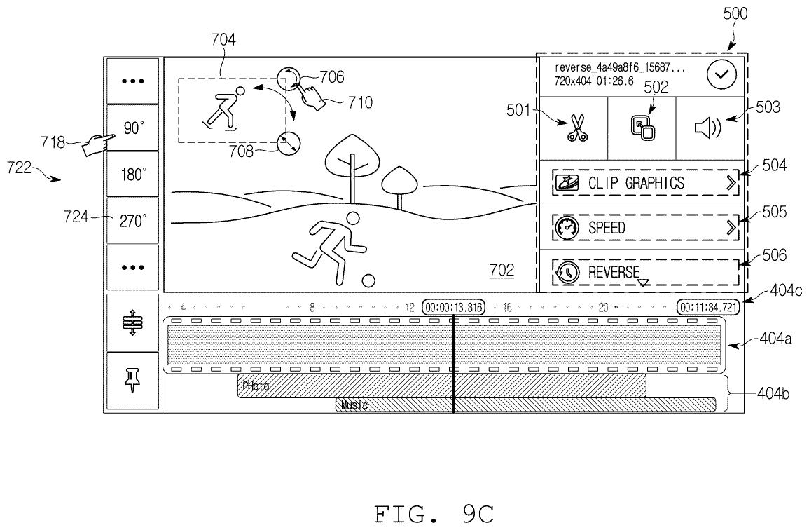

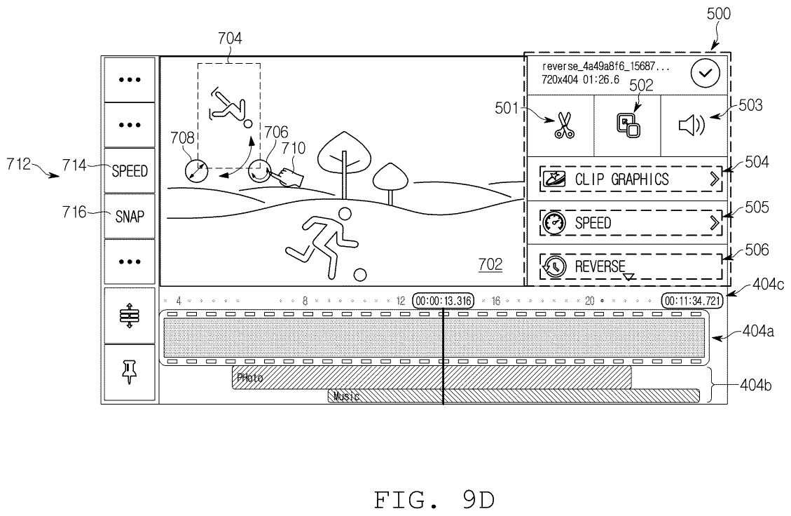

FIGS. 9A to 9D are diagrams illustrating as an example a process of implementing a content editing method according to another embodiment of the present disclosure. FIGS. 10A to 10D are diagrams illustrating as another example a process of implementing a content editing method according to another embodiment of the present disclosure.

In this disclosure, it is assumed that objects are main media 702, layer media 704, main clips 802a to 802c, and sub clips 804a to 804d, and objects to be changed are layer media 704 and sub clips 804a to 804d. FIGS. 9A to 9D illustrate that the object to be changed is the layer media 704, and FIGS. 10A to 10D illustrate that the objects to be changed are the sub clips 804a to 804d. In addition, in the present disclosure, as in FIG. 6, performing a user object change after a video project of pre-edited content is loaded will be focused upon, but of course, it may also be applied to initial editing using original media.

As illustrated in FIG. 9A, the processor 120 may control the original media selected as the layer media 704 to overlap a predetermined portion of the main media 702 according to the user's request, and also provide the sub clips 804a to 804d of the layer media 704 to the clip display window 404 (S305).

As another example of step S305, the processor 120 may recognize the sub clip 804c selected by the user's first touch input 710 in the clip display window 404, as illustrated in FIG. 10A.

Next, the processor 120 may detect predetermined input 710 for the user's layer media 704 received by the display 160, as illustrated in FIG. 9A, and determine that the change of the layer media 704 is initiated (S310).

Specifically, FIG. 9A illustrates rotation of the layer media 704 in a predetermined direction by the first touch input 710 to the layer rotation input unit 706. The first touch input 710 may be a drag gesture that rotates the layer media 704 in a predetermined direction.

As another example of step S310, FIG. 10A illustrates movement of the sub clip 804c to a desired position by a drag gesture (first touch input 710) for the sub clip 804c.

Next, as illustrated in FIG. 9B, upon detecting the initiation of the change of the layer media 704, the processor 120 may provide an adjustment menu 712 according to the type of object change to the display 160 (S315).

Specifically, when determining that the first touch input 710 related to the rotation of the layer media 704 by the layer rotation input unit 706 is continuously performed and maintained, the processor 120 may display the adjustment menu 712. In the example of FIG. 9B, the processor 120 may determine that the type of object change is a rotation change of the layer media 704 through the layer rotation input unit 706, and present the speed adjustment activation key 714 and the snap activation key 716 as the adjustment control types 714 and 716 matching the type.

As another example of step S315 related to FIG. 10B, when determining that the first touch input 710 related to the movement of the sub clip 804c is continuously performed and maintained, the processor 120 may display the adjustment menu 712. The processor 120 may determine that the type of object change is movement of the sub clip 804c, and present the speed adjustment activation key 714 and the snap activation key 716 as the adjustment control types 714 and 716 matching the type.

Subsequently, as illustrated in FIGS. 9C and 10C, when the user selects the snap activation key 714 as the adjustment control type through the second touch input 718, the processor 120 may activate the snap function (S320).

In the present disclosure, the snap function is described as being activated by generating the second touch input 718 while the first touch input 710 is maintained. However, in another example, even if the first touch input 710 is released, the snap function may be displayed.

Next, the processor 120 may present a snap detail list 722 on the display 160, as illustrated in FIG. 9C (S325).

The snap detail list 722 may provide at least one alignment reference object 724 according to the drag gesture (first touch input 710) of the layer rotation input unit 706, such as an adjustment item including an alignable rotation angle option. In FIG. 9C, the snap detail list 722 is illustrated as a discrete rotation option button, but may be expressed in various types of interfaces.

As another example of step S325 related to FIG. 10C, the processor 120 may provide the adjustment item including at least one alignment reference object 724a according to the drag gesture (first touch input 710) of the sub clip 804c, such as an alignable baseline 404d, a start or end point of each of the main clips 802a to 802c, other sub clips 804a, 804b and 804d, etc. The alignment reference object 724a illustrated in FIG. 10C may be points of each clip that may be aligned with the start point of the sub clip 804c. This adjustment item is a type of snap detail list 722a. In addition to the example in FIG. 10C, the snap detail list 722a may be presented in various interfaces as described above.

Next, as illustrated in FIG. 9C, the user may select a detailed function, that is, a rotation angle option, from the snap detail list 722 by second touch input 718, while maintaining the first touch input 710 for the desired shape change, and the processor 120 may receive the input rotation angle. The processor 120 may perform control rotation change of the layer media 704 according to the selected rotation angle (S330). Here, the detailed function may have substantially the same meaning as the alignment reference object.

As in the example of FIG. 9C, as the user changes the rotation angle option of the snap detail list 722 in a state of maintaining the first touch input, the processor 120 may perform various object changes of the layer media 704. The processor 120 may accurately rotate and automatically align the layer media 704 according to the rotation angle option selected through the second touch input 718. As shown in FIG. 9D, if the user selects 90 degrees as the rotation angle option, the layer media 704 may be aligned by accurately rotating by 90 degrees.

As another example of step S330 related to FIG. 10C, as the processor 120 changes the alignment reference object 724a of the snap detail list 72a through the second touch input in a state of maintaining the first touch input 710, the processor 120 may accurately and automatically align the sub clip 804c with a point desired by the user. As shown in FIG. 10D, when the user selects the detailed function PH related to the baseline 404d as the alignment reference object 724a, the sub clip 804c will be accurately aligned with the baseline 404d in the clip display window 404.

Next, if the user deactivates the snap function, the processor 120 may not provide the snap detail list 722 to the display 160 (S335).

Interruption of the snap detail list 722 may be implemented by the user releasing the second touch input 718 from the snap detail list 722 and 722a or turning it off using a separate method, as illustrated in FIGS. 9D and 10D, for example. By deactivating the snap detail list 722, 722a, the processor 120 interrupts the snap function, for example, and when the snap activation key 716 is reselected by the second touch input 718, the processor 120 may provide a snap detail list 722 and 722a based on the type of object change. Even if the snap function is interrupted, the processor 120 may control the change of the corresponding object according to the drag gesture (first touch input 710) based on the default value.

Next, if the user releases the change of object, the processor 120 may deactivate the adjustment menu 712 (S340). Release of the object change may be substantially the same as in step S240.

In the present embodiment, the media rotation alignment and alignment of the clip with the baseline according to the alignment reference object 724 desired by the user will be focused upon, but it may also be applied to various alignment requests processed by the video editing application.

Another example of the clip change similar to FIGS. 10A to 10D may be a change such as trim of the start portion of the main clips 802a to 802c or the layer clips 804a to 804d or trim of the end portions of the clips 802a to 802c and 804a to 804d. In this case, the alignment reference object that may be selected as the point to be cut by trimming is, for example, the baseline 404d, the start or end point of a clip other than a trim clip, or a point between other time-series consecutive clips (e.g., the main clip 802a˜802c), etc. In addition, in the case of movement of the main clips 802a to 802c or layer clips 804a to 804d, the processor 120 may check whether the alignment point of the moving clips 802a to 802c and 804a to 804d is the start or end, so that the alignment reference object according to the alignment point may be presented in the snap detail list. For example, when the end points of the moving clips 802a to 802c and 804a to 804d are the alignment points, the alignment reference object is the baseline 404d, the start or end point of other clips other than the trim clip, and a point between other time-series consecutive clips (e.g., the main clips 802a to 802c), etc.

Regarding the shape change of the layer media 704, as shown in FIG. 6, it may be position movement, rotation or size adjustment of the layer media 704. If the processor 120 detects that the change type is a positional movement or size adjustment of the layer media 704, the snap detail list may have automatic alignment snap in a guide line virtually set and displayed in the video display window, automatic alignment snap in a grid virtually displayed in the video display window. In this case, the alignment reference object may be presented including at least one of the guide line or the grid.

In addition to the above description, it may be applied to the snap function when changing the application of effect elements or automatic alignment through the snap function of an adjustable editing tool. In addition, when the adjustment menu for the object change of the user is activated in the video editing application, the present embodiment may be applied to all situations in which objects are changed to be automatically aligned according to predetermined settings.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A content editing control method for fine adjustment control comprising:
detecting initiation of a change of an object;
presenting an adjustment menu related to the change of the object;
receiving an adjustment item selected by input of a user in the adjustment menu; and
controlling the change of the object according to an instruction of the user based on settings of the adjustment item specified by the user.

2. The content editing control method of claim 1, wherein the object is a media object or an editing tool for editing the media object.

3. The content editing control method of claim 1, wherein the object is provided to a display of an electronic device, and the change of the object is performed by an editing interface provided on the display to receive touch input of the user.

4. The content editing control method of claim 3, wherein the touch input is input by a drag gesture of the user, and the change of the object comprises control of the change of the object based on the drag gesture.

5. The content editing control method of claim 4, wherein the presenting the adjustment menu comprises providing the adjustment menu to the display in a state of maintaining the touch input related to the drag gesture.

6. The content editing control method of claim 4,
wherein the controlling the change of the object according to the instruction of the user is performed in a state of maintaining touch input for the specified adjustment item,
wherein the method further comprises interrupting provision of the adjustment item and presenting an adjustment menu having an adjustment control type according to a type of the change of the object, in response to release of the touch input for the adjustment item; and
interrupting presentation of the adjustment menu in response to release of the touch input related to the drag gesture.

7. The content editing control method of claim 1, wherein the presenting the adjustment menu comprises:
providing the user with at least one adjustment control type according to the type of the change of the object; and
providing the adjustment item based on the adjustment control type selected by the user.

8. The content editing control method of claim 7,
wherein the change of the object is performed by an editing interface for receiving touch input related to the drag gesture of the user, and
wherein the adjustment control type comprises at least one of a snap function or a speed adjustment function according to the drag gesture, and the snap function controls the change of the object to be automatically aligned to a predetermined alignment reference object.

9. The content editing control method of claim 8, wherein the speed adjustment function provides an adjustment item comprising a range from a value smaller than a default value to a larger value based on the default value according to the drag gesture.

10. The content editing control method of claim 8, wherein the adjustment item according to the snap function and the predetermined alignment reference object are determined based on the type of the change of the object.

11. A content editing device for fine adjustment control comprising:
a memory configured to store at least one instruction;
a display configured to display media; and
a processor configured to execute the at least one instruction stored in the memory,
wherein the processor is configured to:
detect initiation of a change of an object;
present an adjustment menu related to the change of the object;
receive an adjustment item selected by input of a user in the adjustment menu; and
control the change of the object according to an instruction of the user based on settings of the adjustment item specified by the user.

12. The content editing device of claim 11, wherein the object is provided to the display, and the change of the object is performed by an editing interface provided on the display to receive touch input of the user.

13. The content editing device of claim 12, wherein the touch input is input by a drag gesture of the user, and the change of the object comprises control of the change of the object based on the drag gesture.

14. The content editing device of claim 13, wherein the presenting the adjustment menu comprises providing the adjustment menu to the display in a state of maintaining the touch input related to the drag gesture.

15. The content editing device of claim 13,
wherein the controlling the change of the object according to the instruction of the user is performed in a state of maintaining touch input for the specified adjustment item, and
wherein the processor is further configured to:
interrupt provision of the adjustment item and present an adjustment menu having an adjustment control type according to a type of the change of the object, in response to release of the touch input for the adjustment item; and
interrupt presentation of the adjustment menu in response to release of the touch input related to the drag gesture.

16. The content editing device of claim 11, wherein the presenting the adjustment menu comprises:
providing the user with at least one adjustment control type according to the type of thee change of the object; and
providing the adjustment item based on the adjustment control type selected by the user.

17. The content editing device of claim 16,
wherein the change of the object is performed by an editing interface for receiving touch input related to the drag gesture of the user, and
wherein the adjustment control type comprises at least one of a snap function or a speed adjustment function according to the drag gesture, and the snap function controls the change of the object to be automatically aligned to a predetermined alignment reference object.

18. The content editing device of claim 17, wherein the speed adjustment function provides an adjustment item comprising a range from a value smaller than a default value to a larger value based on the default value according to the drag gesture.

19. The content editing device of claim 17, wherein the adjustment item according to the snap function and the predetermined alignment reference object are determined based on the type of the change of the object.

20. A computer program stored in a recording medium readable by a computing electronic device to perform a content editing control method for fine adjustment control in the computing electronic device, the method comprising:
detecting initiation of a change of an object;
presenting an adjustment menu related to the change of the object;
receiving an adjustment item selected by input of a user in the adjustment menu; and
controlling the change of the object according to an instruction of the user based on settings of the adjustment item specified by the user.
